(19) United States
(12) Patent Application Publication
(10) Pub. No.: US 2011/0181406 A1
(43) Pub. Date: Jul. 28, 2011

(54) DISPLAY SYSTEM AND VEHICLE HAVING THE SAME

(75) Inventor: Tsung-Yu LIN, Tu-Cheng (TW)

(73) Assignee: HON HAI PRECISION INDUSTRY CO., LTD., Tu-Cheng (TW)

(21) Appl. No.: 12/857,563

(22) Filed: Aug. 17, 2010

(30) Foreign Application Priority Data
Jan. 27, 2010 (TW) 99102328

(51) Int. Cl. B60Q 1/00; H04N 7/18

(52) U.S. Cl. 340/425.5; 348/148; 348/E07.086

(57) ABSTRACT

A display system for a vehicle includes an image capture module, a control module, and a display module. The image capture module includes a left camera and a right camera mounted on left and right sides of the vehicle to capturing images of surrounding traffic. The control module includes a receiving unit which receives the images of surrounding traffic captured by the left camera or the right camera, and a generating unit which generates a first displaying signal after the receiving unit receiving the images of surrounding traffic from the left camera and generates a second displaying signal after the receiving unit receiving the images of surrounding traffic from the right camera. The display module displays the dynamic images of traffic captured by the left and right cameras when receiving the displaying signals.

### BACKGROUND

1. Technical Field

The present disclosure generally relates to display systems, and particularly, to a display system providing single traffic image for a driver in a vehicle, and a vehicle utilizing the display system.

2. Description of Related Art

With developments in automotive technology, performance, aerodynamics, and safety have been geared to meet the desires of consumers. Rearview mirrors used in automobiles allow the driver to see the area to the rear of vehicle. However, the rearview mirrors provide only limited vision for the driver. As a result, camera systems are used on the automobiles for enlarging/widening the field of view from within the driving compartment.

Generally, the camera system includes a plurality of cameras and a corresponding display system, the display system is connected to all of the cameras and continuously displays the traffic image captured by the cameras at the same time. However, especially for a new driver, the complicated traffic images are difficult to distinguish, thus making the driver slow in judging or even leading to a wrong decision.

Therefore, it is desirable to provide a display systems and a vehicle utilizing the display system, which can overcome the problem described above.

### BRIEF DESCRIPTION OF THE DRAWINGS

FIG. 1 is a schematic, top view of a vehicle with a display system according to an exemplary embodiment.

FIG. 2 is a functional block diagram of the display system of FIG. 1.

### DETAILED DESCRIPTION

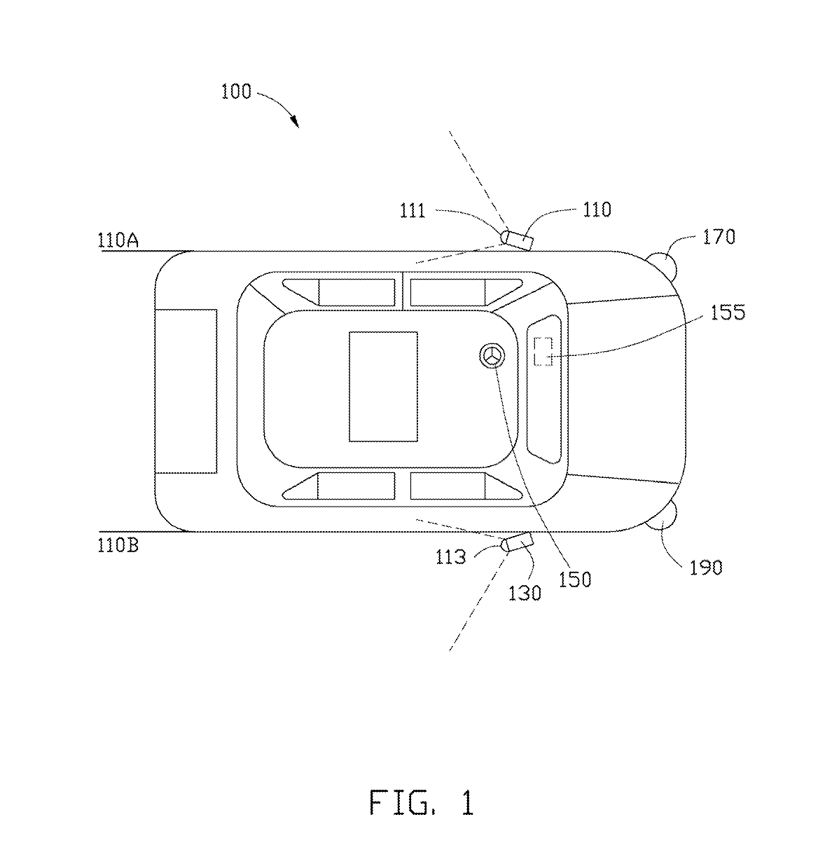

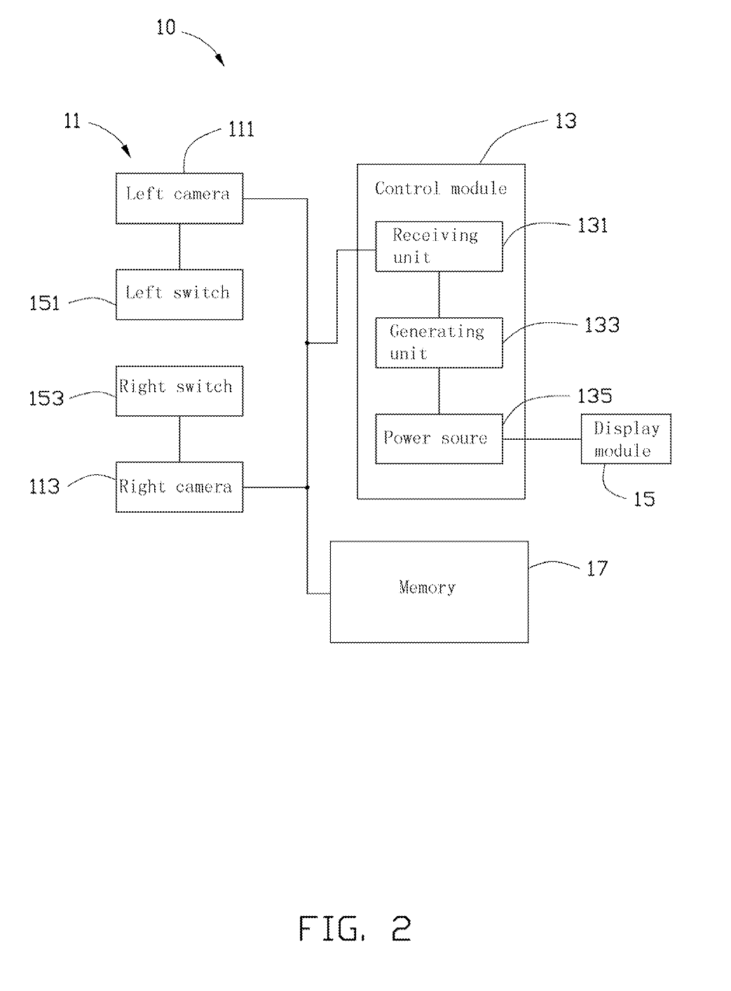

Referring to FIGS. 1 and 2, a display system 10, in accordance with an exemplary embodiment, is shown, while here, installed in a vehicle 100.

The vehicle 100 employing the display system 10 includes a left side rearview mirror 110, a right side rearview mirror 130, and a steering wheel 150. The steering wheel 150 includes a turn signal lever (not shown), for a driver to turn on/off a left turn signal lamp 170 or a right turn signal lamp 190 disposed outside the vehicle 100. In detail, the turn signal lever employs a left switch 151 which is connected to the left turn signal lamp 170 and configured for turning on/off the left turn signal lamp 170, and a right switch 153 which is connected to the right turn signal lamp 190 and configured for turning on/off the right turn signal lamp 190. In the present embodiment, the left switch 151 and the right switch 153 are integrated to be a single-pole double throw switch.

The display system 10 includes an image capture module 11, a control module 13, and a display module 15.

The image capture module 11 includes a number of cameras arranged on the lateral anterior sides 110A, 110B of the vehicle 100. The image capture module 11 captures the image of surrounding traffic on the road. While here, the image capture module 11 includes a left camera 111 mounted on the left side rearview mirror 110 for capturing the image of surrounding traffic on the left side of the vehicle 100, and a right camera 113 mounted on the right side rearview mirror 130 for capturing the image of surrounding traffic on the right side of the vehicle 100. Generally, the left camera 111 and the right camera 113 can be positioned below the bonnet of the rearview mirrors 110 and 130. The left camera 111 is connected to the left switch 151 and the right camera 113 is connected to the right switch 153.

Each camera includes a lens and an image sensor as known in the prior art. While here, the lens is a wide-angle lens providing a wider field of view from within the driving compartment of the vehicle 100. The image sensor generates a detected signal of the image of surrounding traffic and provides the image of the surrounding traffic to the control module 13 according to the states of the left switch 151 and the right switch 153. The image sensor can be a charge-coupled system (CCD) or a complementary metal oxide semiconductor system (CMOS). In the present embodiment, the image of the surrounding traffic is a dynamic image.

The control module 13 includes a receiving unit 131 and a generating unit 133. The receiving unit 131 is connected to the left and right cameras 111 and 113, and receives the image of the surrounding traffic from the left camera 111 or/and the right camera 113 when the left switch 151 or/and the right switch 153 is turned on. While here, due to the left switch 151 and the right switch 153 are integrated to be a single-pole double throw switch, when the left switch 151 is turned on, the right switch 153 is turned off, and vice versa. Therefore, when the left switch 151 is turned on by the driver, only the left camera 111 is triggered by the left switch 151 to communicate with the receiving unit 131. In this condition, the receiving unit 131 receives the image of surrounding traffic from the left camera 111. Similarly, when the right switch 153 is turned on, the receiving unit 131 receives only the image of surrounding traffic from the right camera 113. Furthermore, the receiving unit 131 also transmits the image of surrounding traffic from the left camera 111 or the right camera 113 to the generating unit 133 directly.

The generating unit 133 generates the display module 15 to display the corresponding image of surrounding traffic after the receiving unit 131 transmits the corresponding image of surrounding traffic. In detail, here, when the receiving unit 131 transmits the image of surrounding traffic from the left camera 111, the generating unit 133 generates a first displaying signal to the display module 15. Similarly, when the receiving unit 131 transmits the image of the surrounding traffic from the right camera 113, the generating unit 133 generates a second displaying signal to the display module 15.

The display module 15 is connected to the control module 13 and receives the transmitted signal therefrom and displays the corresponding dynamic image of the surrounding traffic. The display module 15 includes a monitor 155 disposed in front of the driver and connected to the control module 13. Generally, the monitor 155 is positioned below the front window of the vehicle 100. In the present embodiment, the monitor 155 is a LCD-type display. When the display module 15 receives the first displaying signal, the monitor 155 displays only the image of surrounding traffic captured by the right camera 113 via the control module 13. Similarly, when the display module 15 receives the second displaying signal, the monitor 155 displays only the image of surrounding traffic captured by the left camera 111 via the control module 13. That is to say, the display module 15 can properly and timely display the image of surrounding traffic captured by the left camera 111 or the right camera 113. As such, when the vehicle 100 needs to turn right, the driver will only see the image of surrounding traffic on the right side of the vehicle 100; when the vehicle 100 needs to turn left, the driver will only see the image of surrounding traffic on the left side of the vehicle 100. Therefore, a driver can accurately monitor the area and conditions to the corresponding side of vehicle 100 when turning left or right.

Furthermore, when both of the left switch 151 and the right switch 153 are turned off, the control module 13 shuts down the monitor 155 or places the monitor 155 on standby.

Furthermore, the control module 13 includes a power source 135 connected to the generating unit 133. The power source 135 is configured for supplying power to the control module 13 and the display module 15.

In other embodiments, the vehicle 100 can further include a memory 17 for continuously storing the dynamic image of surrounding traffic captured by the left camera 111 and the right camera 113. The memory 17 is connected to both of the left camera 111 and the right camera 113. In the present embodiment, the memory 17 is a flash memory.

In other embodiments, the left switch 151 and the right switch 153 may be independent from each other. In this case, the display module 15 can include two or more monitors 155 respectively connected to the left switch 151 and the right switch 153. The two or more monitors 155 are respectively mounted on the inner sides of the vehicle 100 (such as below the windshields). When the left switch 151 is turned on, the corresponding monitor 155 will display the image of surrounding traffic captured by the left camera 111. When the right switch 153 is turned on, the corresponding monitor 155 will display the image of surrounding traffic captured by the right camera 113. As such, the driver can see the corresponding image of surrounding traffic very efficiently and conveniently.

While various exemplary and preferred embodiments have been described, it is to be understood that the disclosure is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A display system for a vehicle, the vehicle comprising a left switch and a right switch controlling the left turn signal lamp and the right turn signal lamp of the vehicle respectively, the display system comprising:
an image capture module comprising at least one left camera and at least one right camera mounted on left and right sides of the vehicle to capturing images of surrounding traffic;
a control module comprising a receiving unit and a generating unit, the receiving unit being connected to the left and right cameras and configured for receiving the images of surrounding traffic captured by the left cameras or the right cameras according to the states of the left and right switches; the generating unit being connected to the receiving unit and configured for generating a first displaying signal after the receiving unit receives the images of surrounding traffic from the left cameras or generating a second displaying signal after the receiving unit receives the images of surrounding traffic from the right cameras; and
a display module connected to the control module and configured for displaying the images of the surrounding traffic captured by the left cameras when the first displaying signal is received or displaying the images of surrounding traffic captured by the right cameras when the second displaying signal is received.

2. The display system of claim 1, wherein the vehicle further comprises a left side rearview mirror and a right side rearview mirror, the image capture module comprising only one left camera mounted on the left side rearview mirror for capturing images of surrounding traffic on the left side of the vehicle, and only one right camera mounted on the right side rearview mirror for capturing images of surrounding traffic on the right side of the vehicle.

3. The display system of claim 1, wherein the left switch and the right switch are integrated to be a single-pole double throw switch.

4. The display system of claim 1, wherein the left switch and the right switch are independent from each other and respectively connected to the left cameras and the right cameras.

5. The display system of claim 3, wherein the display module includes a monitor disposed in front of the driver and connected to the control module, when the display module receives the first displaying signal, the monitor displays only the image of surrounding traffic captured by the right cameras via the control module, when the display module receives the second displaying signal, the monitor displays only the image of surrounding traffic captured by the left cameras via the control module.

6. The display system of claim 4, wherein the display module comprises two or more monitors respectively connected to the left switch and the right switch, the monitors are respectively mounted on the inner sides of the vehicle, when the left switch is turned on, the corresponding monitor displays the images of surrounding traffic captured by the left cameras, when the right switch is turned on, the other monitor displays the images of surrounding traffic captured by the right cameras.

7. The display system of claim 4, wherein the control module shuts down the monitor or places the monitor on standby when both of the left switch and the right switch are turned off.

8. The display system of claim 1, wherein the control module further comprises a power source connected to the generating unit, the power source is configured for supplying power to the control module and the display module.

9. The display system of claim 1, further comprising a memory connected to the left cameras and the right cameras and configured for continuously storing the images of surrounding traffic captured by the left cameras and the right cameras.

10. A display system for a vehicle, the vehicle comprising a left switch and a right switch controlling a left turn signal lamp and a right turn signal lamp of the vehicle respectively, the display system comprising:
at least one left camera and at least one right camera mounted on a left and a right side of the vehicle to capture images of surrounding traffic of the vehicle;
a receiving unit in communication with the left and right cameras and configured for receiving the images of the surrounding traffic captured by the left cameras or the right cameras according to the states of the left and right switches;
a generating unit in communication with the receiving unit and configured for generating a first displaying signal after the receiving unit receives the images of the surrounding traffic from the left cameras, or generating a second displaying signal after the receiving unit receives the images of the surrounding traffic from the right cameras; and
a display module in communication with the generating unit and configured for displaying the images of the surrounding traffic captured by the left cameras when the first displaying signal is received or displaying the images of the surrounding traffic captured by the right cameras when the second displaying signal is received.

11. A vehicle, comprising:
a steering wheel, the steering wheel comprising a left switch and a right switch for respectively controlling the left turn signal lamp and the right turn signal lamp of the vehicle; and
a display system comprising:
an image capture module comprising at least one left camera and at least one right camera mounted on left and right sides of the vehicle to capturing images of surrounding traffic;
a control module comprising a receiving unit and a generating unit, the receiving unit being connected to the left and right cameras and configured for receiving the images of surrounding traffic captured by the left cameras or the right cameras according to the states of the left and right switches; the generating unit being connected to the receiving unit and configured for generating a first displaying signal after the receiving unit receives the images of surrounding traffic from the left cameras or generating a second displaying signal after the receiving unit receives the images of surrounding traffic from the right cameras; and
a display module connected to the control module and configured for displaying the images of the surrounding traffic captured by the left cameras when the first displaying signal is received or displaying the images of surrounding traffic captured by the right cameras when the second displaying signal is received.
